(19) United States
(12) Patent Application Publication
(10) Pub. No.: US 2025/0284223 A1
(43) Pub. Date: Sep. 11, 2025

(54) IMAGE FORMING APPARATUS

(71) Applicant: CANON KABUSHIKI KAISHA, Tokyo (JP)

(72) Inventor: TAKUYA MUKAIBARA, Shizuoka (JP)

(21) Appl. No.: 19/063,503

(22) Filed: Feb. 26, 2025

(30) Foreign Application Priority Data
Mar. 7, 2024 (JP) 2024-035282

(51) Int. Cl. G03G 15/08; H02M 7/48; H02M 7/757

(52) U.S. Cl. CPC G03G 15/086; H02M 7/4818; H02M 7/7575; G03G 2215/0651

(57) ABSTRACT

A high voltage generating device includes a booster and a driver. The booster includes first and second inductors connected in series and a capacitor connected in parallel to the first inductor. One end of the first inductor is connected to a DC voltage. The driver is connected in series to the second inductor and performs a switching operation by a driving signal. An inductance L2 of the second inductor is larger than an inductance L1 of the first inductor. The driver performs the switching operation at the driving frequency f of the driving signal within f0≤f≤f1. The f0 is a resonance frequency by the first inductor and the capacitor, and the f1 is a resonance frequency by the capacitor and the first and second inductors. The booster is driven by the driver and generates a sine wave AC high voltage higher than the DC voltage.

### FIELD OF THE INVENTION AND RELATED ART

The present invention relates to an image forming apparatus.

The image forming apparatus performs a toner remaining amount detection to notify a toner remaining amount. One of a toner remaining amount detecting means is a toner remaining amount detection of electrostatic capacitance detection type using an AC high voltage. For example, in Japanese Patent Application Laid-Open No. 2009-251099, a sine wave high voltage is generated by utilizing a bandpass filter function of a piezoelectric transformer, which is a resonant body. In contrast to a conventional circuit, which generates high voltage by driving a winding transformer for high voltage with sine wave, in Japanese Patent Application Laid-Open No. 2009-251099, a method which intends to reduce cost, downsize and save energy of a circuit by reducing a number of components is disclosed.

### SUMMARY OF THE INVENTION

However, in recent years, there is a problem that cost of the piezoelectric transformer, which is used, becomes higher relative to the winding transformer for high voltage. On the other hand, in a conventional high voltage generating device, an AC voltage for the toner remaining amount detection having an approximate sine waveform is generated by using a bandpass filter, a push-pull amplifying circuit and the winding transformer for high voltage. Even with such a high voltage generating device, cost is still high and, in addition, there is a problem that electric power efficiency is not good.

The present invention is conceived under such a background, and an object of the present invention is, with a more compact and inexpensive configuration, to generate a sine wave AC high voltage with good electric power efficiency.

In order to solve the aforementioned problems, the present invention includes the following configurations.

(1) A high voltage generating device for converting a DC voltage to an AC voltage, the high voltage generating device comprising: a boosting portion including a first inductor of which one end is connected to the DC voltage or a ground potential, a second inductor of which one end is connected in series to the other end of first inductor, and a capacitor of which both ends are connected in parallel to the first inductor; and a driving portion connected in series to the other end of the second inductor and configured to perform a switching operation by a driving signal, wherein an inductance value L2 of the second inductor is larger than an inductance value L1 of the first inductor, wherein when a resonance frequency by the first inductor and the capacitor is defined as a first frequency f0, a resonance frequency by the capacitor and both the first inductor and the second inductor is defined as a second frequency f1, and a driving frequency of the driving signal is defined as a driving frequency f, the driving portion performs the switching operation at the driving frequency f within a range of f0≤f≤f1, and wherein the boosting portion is driven by the driving portion and generates a sine wave AC high voltage higher than the DC voltage.

(2) An electrostatic capacitance detecting device comprising: a first electrode member; and a second electrode member paired with the first electrode member, wherein the electrostatic capacitance detecting device detects an electrostatic capacitance between the first electrode member and the second electrode member and is provided with a high voltage generating device according to (1), and wherein the high voltage generating device applies the sine wave AC high voltage to the first electrode member.

(3) An image forming apparatus comprising: an image bearing member configured to bear an electrostatic latent image; a developing means configured to develop the electrostatic latent image with toner and form a toner image; an accommodating chamber configured to accommodate the toner to be supplied to the developing means; and a electrostatic capacitance detecting device attached to the accommodating chamber and according to (2), wherein the electrostatic capacitance detecting device detects an electrostatic capacitance of the toner entered between the first electrode member and the second electrode member, and the image forming apparatus is provided with an estimating means configured to estimate an amount of the toner accommodated in the accommodating chamber based on the electrostatic capacitance detected by the electrostatic capacitance detecting device.

Further features of the present invention will become apparent from the following description of exemplary embodiments with reference to the attached drawings.

### BRIEF DESCRIPTION OF THE DRAWINGS

FIG. 1 is a view illustrating an image forming apparatus in Embodiments 1 through 3.

FIG. 2, part (a) and part (b), includes views illustrating detail of a process cartridge in the Embodiments 1 through 3.

FIG. 3 is a view illustrating a detection waveform of a toner remaining amount detection in the Embodiments 1 through 3.

FIG. 4 is a block diagram illustrating a high voltage generating device in the Embodiment 1.

FIG. 5 is a view illustrating detail of a circuit of a boosting portion in the Embodiment 1.

FIG. 6, part (a), part (b), part (c), part (d), part (e) and part (f), includes views illustrating frequency response of an impedance of the boosting portion in the Embodiments 1 through 3.

FIG. 7, part (a) and part (b), includes views illustrating a driving voltage waveform and a current waveform of the boosting portion in the Embodiment 1.

FIG. 8, part (a), part (b), part (c), part (d), part (e) and part (f), includes views illustrating relationship between an inductance L2 and a boosting ratio, a consumed current and a series resonance frequency.

FIG. 9 is a block diagram illustrating a high voltage generating device in the Embodiment 2.

FIG. 10, part (a) and part (b), includes views illustrating relationship between a driving frequency and a consumed current and an applying and outputting voltage in the Embodiment 2

FIG. 11, part (a) and part (b), includes views illustrating detail of a circuit of a boosting portion in the Embodiment 2.

FIG. 12 is a view illustrating detail of a circuit of a boosting portion in the Embodiment 3.

### DESCRIPTION OF THE EMBODIMENTS

Hereinafter, Embodiments will be described in detail with reference to the accompanying drawings. Incidentally, the Embodiments below are not intended to limit the invention according to the claims. In the Embodiments, a plurality of characteristics are described, however, it is not necessarily all of these plurality of the characteristics are essential to the invention, and in addition, the plurality of the characteristics may be combined arbitrarily. Furthermore, in the accompanying drawings, to the same or similar configurations, the same reference numerals are given, and duplicated descriptions will be omitted.

In the present invention, a configuration, which replaces to highly versatile and inexpensive components and a simple circuit by using with combining both characteristics of a bandpass filter function by a series resonance current and making a power supply line have high impedance by a parallel resonance, is employed. By this, a number of components is reduced and the components become to include only highly versatile circuit components, and it becomes possible to reduce cost, size and loss of a circuit. Hereinafter, the Embodiments of the present invention will be described.

### Embodiment 1

### (Image Forming Apparatus)

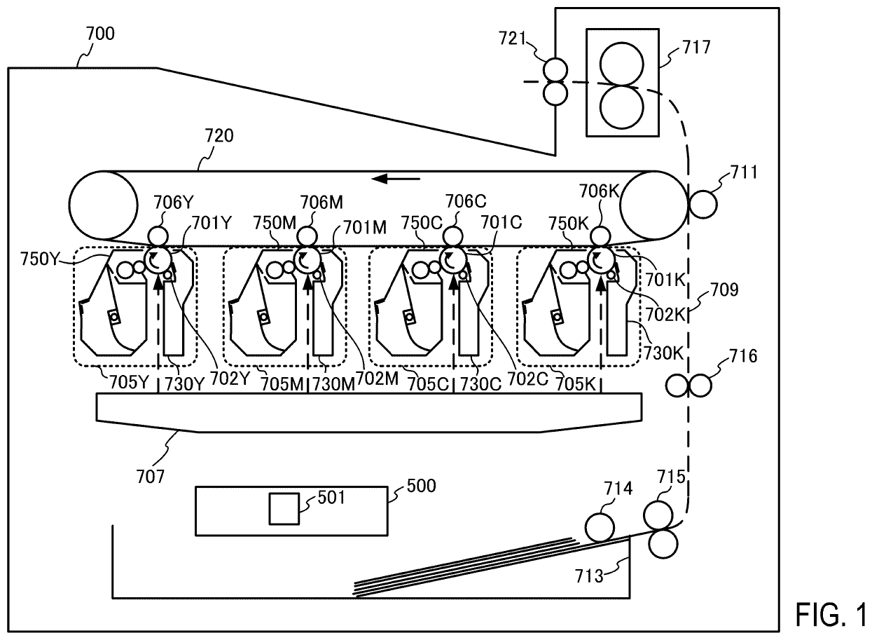

FIG. 1 is a configuration view of an image forming apparatus 700 in an Embodiment 1. Incidentally, letters Y, M, C and K at ends of reference numerals indicate that colors of toner images, which are formed by members indicated by the reference numerals, are yellow, magenta, cyan and black, respectively. Incidentally, in the description below, in cases in which it is not necessary to distinguish between colors, the reference numerals without the trailing letters Y, M, C and K will be used.

The image forming apparatus 700 includes a process cartridge 705, which is mountable thereto and demountable therefrom. A photosensitive drum 701 of the process cartridge 705 is rotationally driven in a clockwise direction in FIG. 1 during image formation. A charging portion 702 charges a surface of the photosensitive drum 701, which is an image bearing member to be rotated, to uniform potential. An exposing portion 707 exposes the surface of each photosensitive drum 701 to form an electrostatic latent image on each photosensitive drum 701. A developing unit 750 forms a toner image on the photosensitive drum 701 by developing the electrostatic latent image on the photosensitive drum 701 with toner. A primary transfer roller 706 transfers the toner image on the photosensitive drum 701 to an intermediary transfer belt 720. Incidentally, during the image formation, the intermediary transfer belt 720 is rotationally driven in a counterclockwise direction in FIG. 1. By transferring the toner image on each photosensitive drum 701 so as to be superimposed on each other onto the intermediary transfer belt 720, a full-color toner image is formed on the intermediary transfer belt 720 (primary transfer). The toner image on the intermediary transfer belt 720 is conveyed to an opposing position to a secondary transfer roller 711 by the rotation of the intermediary transfer belt 720.

Meanwhile, a recording material in a cassette 713 is conveyed, by conveyance rollers 714, 715 and 716, along a conveyance path 709 to the opposing position to secondary transfer roller 711. The secondary transfer roller 711 transfers the color toner image on the intermediary transfer belt 720 to the recording material (secondary transfer). The recording material, on which the unfixed toner image has been transferred, is conveyed to a fixing portion 717. The fixing portion 717 heats and presses the recording material to fix the toner image to the recording material. The recording material is then discharged out of the apparatus by a discharging roller 721. A control portion 500 is provided with a microcomputer 501, and controls the entire image forming apparatus 700.

### (Process Cartridge)

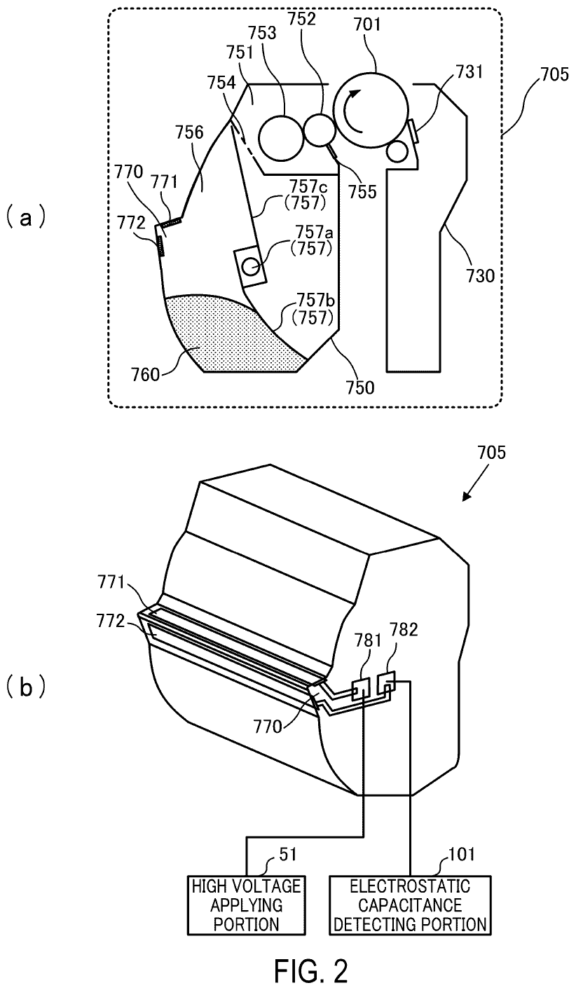

Next, the process cartridge 705 will be described in more detail using FIG. 2. Part (a) of FIG. 2 is a cross-sectional view of the process cartridge 705 and part (b) of FIG. 2 is a perspective view thereof. The process cartridge 705 is constituted by the photosensitive drum 701, a cleaning unit 730 and the developing unit 750. A cleaning blade 731, which is provided to the cleaning unit 730, removes the toner remaining on the surface of the photosensitive drum 701 after the primary transfer (remaining toner). The toner removed from the surface of the photosensitive drum 701 by the cleaning blade 731 is accommodated in a waste toner accommodating chamber disposed in the cleaning unit 730.

The developing unit 750 includes a developing chamber 751, a toner accommodating chamber 756 (accommodating chamber) and a communicating opening 754, which communicates the developing chamber 751 and the toner accommodating chamber 756. In the developing chamber 751, a developing roller 752, a supplying roller 753, and a developing blade 755 are provided as developing means for supplying the toner to the photosensitive drum 701. The developing roller 752 carries the toner, and conveys the toner to the photosensitive drum 701 by contacting the photosensitive drum 701 while being rotated during the image formation. The supplying roller 753 is rotated while contacting the developing roller 752. In addition, the developing blade 755 as a layer thickness regulating member, which regulates a thickness of the toner layer formed on the developing roller 752, is disposed so as to be in contact with a surface of the developing roller 752.

In the toner accommodating chamber 756, a stirring member 757 for stirring accommodated toner 760 and conveying the toner to the supplying roller 753 via the communicating opening 754 is provided. The stirring member 757 includes a rotation shaft 757a, which is parallel to a rotational axis direction of the developing roller 752, and stirring sheets 757b and 757c, which are flexible sheets. One ends of the stirring sheets 757b and 757c are attached to the rotation shaft 757a, while the other ends are free ends, and the toner 760 is stirred by the stirring sheets 757b and 757b being rotated by rotation of the rotation shaft 757a. Incidentally, the developing chamber 751 is positioned above the toner accommodating chamber 756, and the toner 760 in the toner accommodating chamber 756, which is scraped up by the stirring member 757, is supplied to the developing chamber 751 through the communicating opening 754.

In an inner wall of the toner accommodating chamber 756, a recessed portion 770 is formed. The recessed portion 770 is provided at a position where the toner falls, in a state in which the toner 760 is not stirred, by its own weight without staying. Furthermore, in an inner wall of the recessed portion 770, a first conductive member 771 as a first electrode member and a second conductive member 772 as a second electrode member, which is paired with the first conductive member 771, are provided approximately parallel to the rotational axis direction of the developing roller 752. In addition, a shape of the recessed portion 770, as seen from the rotational axis direction (a thrust direction) of the developing roller 752, is triangular. For the first conductive member 771 and the second conductive member 772, a sheet member such as a sheet metal, such as SUS, and conductive resin.

### (Method for a Toner Remaining Amount Detection)

Next, a method for a toner remaining amount detection will be described. In the Embodiment 1, by the toner passing through the two sheets of the conductive members, which are provided in the recessed portion 770 described above, a voltage, which is detected based on electrostatic capacitance of the toner, changes. Then, from a waveform of the detected voltage, a time width, during which the toner is entering the recessed portion 770, is measured, and an overall toner amount in the toner accommodating chamber 756 is estimated.

To the process cartridge 705, a first contact portion 781, which is electrically connected to the first conductive member 771, and a second contact portion 782, which is electrically connected to the second conductive member 772, are provided. To the first contact portion 781, an AC voltage is applied by a high voltage applying portion 51. An alternating current due to the electrostatic capacitance between the first conductive member 771 and the second conductive member 772 is converted to voltage and detected by an electrostatic capacitance detecting portion 101 as an electrostatic capacitance detecting device via the second contact portion 782. Incidentally, the high voltage applying portion 51 corresponds to a high voltage generating device, which converts a DC voltage to an AC voltage.

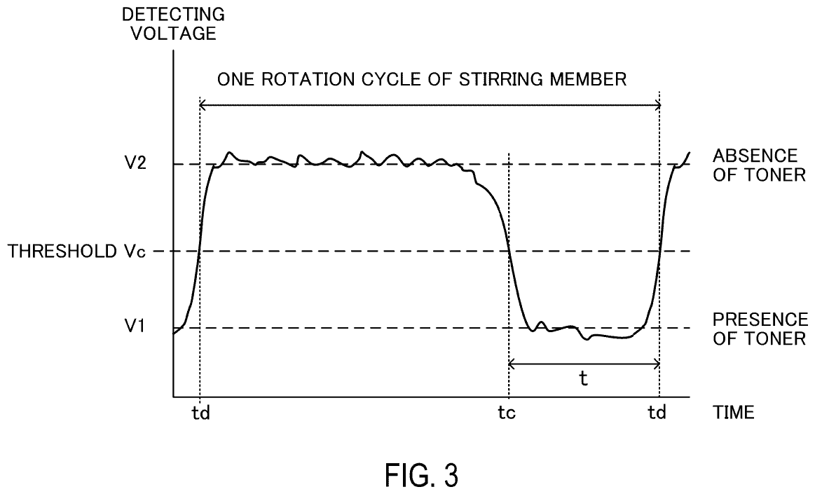

FIG. 3 is a view illustrating a voltage waveform detected by the electrostatic capacitance detecting portion 101, and a horizontal axis represents time and a vertical axis represents the voltage which is detected (detected voltage). Incidentally, a high voltage applied to the first contact portion 781 by the high voltage applying portion 51 has, for example, a voltage amplitude of 100 through 200 V and a frequency of several tens kHz.

Since dielectric constant of the toner is higher than that of air, when the toner 760 conveyed by the stirring member 757 enters the recessed portion 770 (when the toner presents), the electrostatic capacitance between the first conductive member 771 and the second conductive member 772 increases. On the other hand, when the stirring member 757 passes through the recessed portion 770 and the toner in the recessed portion 770 falls by its own weight (when the toner does not present), the toner is discharged from the recessed portion 770 and the electrostatic capacitance between the first conducting member 771 and the second conducting member 772 decreases. In other words, a time width t, during which the toner passes through between the first conductive member 771 and the second conductive member 772 by the stirring member 757, changes cyclically depending on a staying amount of the toner in the recessed portion 770 (referred to as a toner staying amount). By utilizing this cyclical change, the toner remaining amount in the toner accommodating chamber 756 is estimated. The microcomputer 501 as an estimating means estimates, based on the electrostatic capacitance detected by the electrostatic capacitance detecting portion 101, the toner amount accommodated in the toner accommodating chamber 756.

As shown in FIG. 3, a detected voltage V₁ based on the electrostatic capacitance when the toner presents in the recessed portion 770 and a detected voltage V2 based on the electrostatic capacitance when the toner does not present in the recessed portion 770 are significantly different. In this case, a threshold value Vc is set, and by using the threshold value Vc as a reference, whether or not the toner is entering the recessed portion 770 is detected. A time when the toner enters the recessed portion 770 and the detected voltage reaches the threshold value Vc is defined as tc. A time when the toner in the recessed portion 770 is discharged and the detected voltage reaches the threshold value Vc is defined as td. Incidentally, time from the time td (or the time tc) to the next time td (or the time tc) is a cycle in which the stirring member 757 makes one full turn.

A time width t (t=td−tc) from the time tc to the time td, during which the output voltage is below the threshold value Vc, is measured as a time during which the toner is entering the recessed portion 770. The time width t changes depending on the toner remaining amount in the toner accommodating chamber 756. Therefore, from the detected voltage based on the electrostatic capacitance detected by the electrostatic capacitance detecting portion 101 and the threshold value Vc, the microcomputer 501 can estimate the toner remaining amount by measuring the time width t shown in FIG. 3.

### (Description for an Overall Circuit)

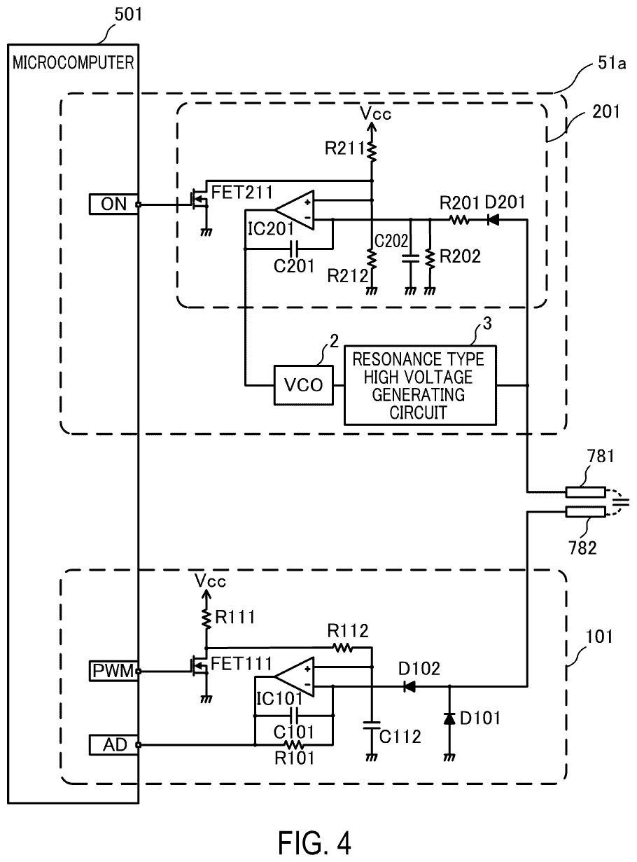

FIG. 4 is a block diagram of a toner remaining amount detection mechanism in the Embodiment 1, and the toner remaining amount detection mechanism is constituted by the microcomputer 501, a high voltage applying portion 51a, the electrostatic capacitance detecting portion 101, the first contact portion 781 and the second contact portion 782 described above. The high voltage applying portion 51a is further constituted by a constant voltage control circuit 201 and a voltage control oscillator 2 (hereinafter referred to as VCO 2).

When the microcomputer 501 outputs an ON signal, the ON signal is input to a gate terminal of a field effect transistor (hereinafter referred to as an FET) 211 of the constant voltage control circuit 201. Incidentally, a source terminal of the FET211 is connected to a ground (hereinafter referred to as GND) potential, and a drain terminal is connected to a DC power source voltage Vcc via a resistor R211. The constant voltage control circuit 201 outputs a predetermined voltage to the VCO 2 in response to the ON signal being input, causing the VCO 2 to output a clock signal of a predetermined frequency to a high voltage generating circuit of resonance type 3. The high voltage generating circuit of resonance type 3 generates a sine wave AC high voltage corresponding to the input clock signal and applies the voltage to the first contact portion 781. Then, the sine wave AC high voltage is subject to feedback control by the constant voltage control circuit 201 so as to keep a predetermined voltage value.

### (Description for the Constant Voltage Control Circuit)

The constant voltage control circuit 201 shown in FIG. 4 is provided with an operational amplifier IC201. In the operational amplifier IC201, so that a predetermined voltage required for the toner remaining amount detection is obtained, a target voltage set by voltage dividing between the resistor R211 and a resistor R212 is input to a non-inverting input terminal (+). To an inverting input terminal (−) of the operational amplifier IC201, a detected voltage, which is divided and half-wave rectified by a diode D201, a resistor R201, a resistor R202 and a capacitor C202 from the generated sine wave AC high voltage, is input. The operational amplifier IC201 sends out a differential signal based on this target voltage and the detected voltage to the VCO 2. The VCO 2 sends out a clock signal of frequency, which corresponds to an input voltage level, to the high voltage generating circuit of resonance type 3. In this manner, the sine wave AC high voltage is subject to the constant voltage control using the feedback control by the VCO 2 and the operational amplifier IC201. The capacitor C201 is a capacitor for phase compensation for the operational amplifier IC201.

### (Description for the Electrostatic Capacitance Detecting Portion)

In the electrostatic capacitance detecting portion 101 shown in FIG. 4, when the AC high voltage is applied to the first contact portion 781, an alternating current flows due to the electrostatic capacitance generated between the first contact portion 781 and the second contact portion 782. Magnitude of the alternating current changes in proportion to the electrostatic capacitance. The diodes D101 and D102 are for rectifying an alternating current, and through each diode, a one-way half-wave current of the alternating current flows. Of this, the current flowing through the diode D102 is input to an integrating circuit, which is constituted by an operational amplifier IC101, a resistor R101, and a capacitor element C101. With using potential of a non-inverting input terminal as a reference, a detected value corresponding to a current value which has flowed is converted to a voltage and output, and the voltage is detected by an AD port of the microcomputer 501.

Incidentally, the output voltage detected by the AD port varies depending on the following factors. For example, the output voltage varies due to variations in the electrostatic capacitance between the first conductive member 771, which is connected to the first contact portion 781, and the second conductive member 772, which is connected to the second contact portion 782, and variations in resistance of the conductive members. In addition, for example, the output voltage also varies due to changes in the dielectric constant of the toner, etc., according to changes in an environment, such as a temperature and a humidity, under which the image forming apparatus 700 is used. Therefore, the potential of the non-inverting input terminal of the operational amplifier IC101, which is used as a reference potential for the detected voltage (input of an inverting input terminal), can be set variably by the microcomputer 501. Specifically, the microcomputer 501 outputs a PWM signal, and an FET111 performs on/off operation according to the PWM signal. The PWM signal is input to a gate terminal of the FET111. Incidentally, a source terminal of the FET111 is connected to the GND potential, and a drain terminal thereof is connected to a DC power source voltage Vcc via a resistor R111. At the drain terminal of the FET111, a pulse signal inverting a logic of the PWM signal output from the microcomputer 501 is generated. The pulse signal is converted to a DC voltage by a low pass filter, which is constituted by a resistor R112 and a capacitor C112, and is input to the non-inverting input terminal of the operational amplifier IC101.

### (High Voltage Generating Circuit of Resonance Type)

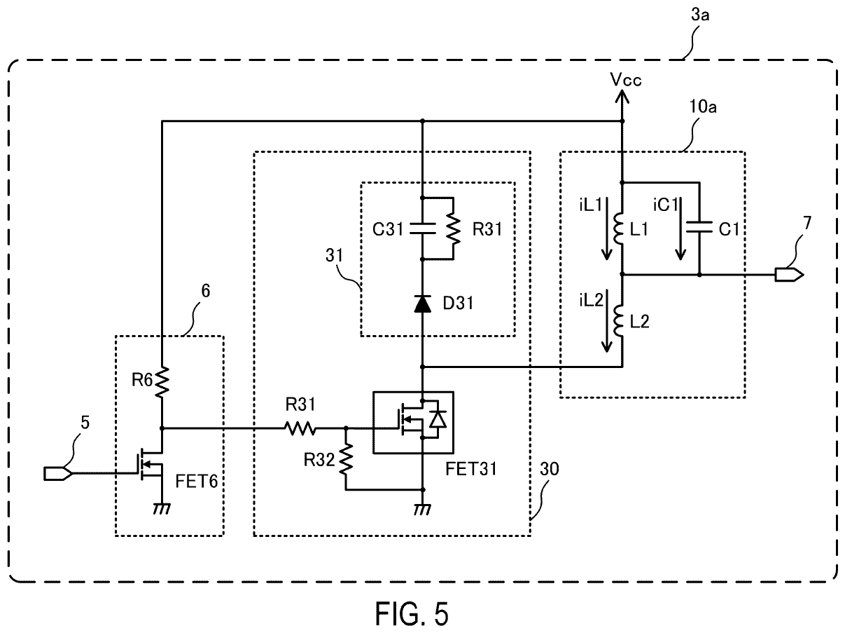

Next, details of the high voltage generating circuit of resonance type 3 will be described. A high voltage generating circuit of resonance type 3a of a single-ended drive system in the Embodiment 1 is shown in FIG. 5. The high voltage generating circuit of resonance type 3a is constituted by a voltage conversion switching portion 6, a driving portion 30 and a boosting portion 10a. The voltage conversion switching portion 6 converts a clock signal 5 with a wave height value of 3.3 V, for example, which is sent out from the VCO 2 described above, into a clock signal with the wave height value of 24 V, for example, which is the power source voltage Vcc. The clock signal 5 is input to a gate terminal of an FET6 of the voltage conversion switching portion 6. Incidentally, a source terminal of the FET6 is connected to the GND potential, and a drain terminal thereof is connected to the power source voltage Vcc via a resistor R6.

The clock signal with the wave height value of 24 V, which is sent out from the voltage conversion switching portion 6, is divided by a resistor R31 and a resistor R32 to a predetermined wave height value, and input to a gate terminal of an FET31 of the driving portion 30. Incidentally, of the FET31, a source terminal is connected to the GND potential, and a drain terminal thereof is connected to a snubber circuit 31 described below. The FET31 performs switching operation corresponding to a cycle (in other words, frequency (driving frequency)) of the clock signal as a driving signal, which is input to the gate terminal thereof, to perform switching drive of the boosting portion 10a.

The boosting portion 10a is constituted by an inductance element L2 as a second inductor, an inductance element L1 as a first inductor and a capacitor element C1. The boosting portion 10a outputs a voltage corresponding to impedance and frequency response of each element from an applying and outputting portion 7. Incidentally, the inductance elements L1 and L2 are, for example, coils.

At the drain terminal of the FET31, the snubber circuit 31, which is constituted by a diode D31, the resistor R31 and a capacitor C31, is provided to suppress a flyback voltage, which is generated at the drain terminal thereof when the FET31 is turned off, to a predetermined voltage or lower.

The inductance element L1 and the capacitor element C1 of the boosting portion 10a are connected in parallel, one ends of which are connected to the power source voltage Vcc (DC voltage), and to another one ends (the other ends) side, one end of the inductance element L2 is connected in series. Another end (the other end) side of the inductance element L2, which is connected in series, is connected to the drain terminal of the FET31. That is, the driving portion 30 is connected in series to the other end of the inductance element L2. As a characteristic of the boosting portion 10a in the Embodiment 1, both parallel resonance frequency and serial resonance frequency are present, and the inductance element L2, which optimizes relationship between both frequencies, is provided.

### (Impedance Characteristics of the Boosting Portion)

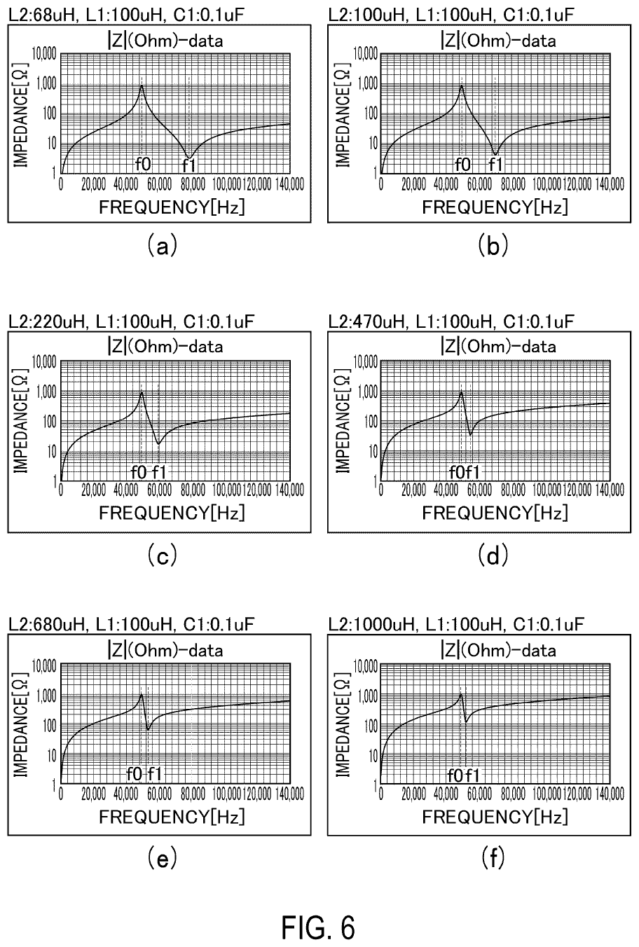

Of frequency response of impedance of the boosting portion 10a, results measured by using a winding inductor of drum shape and a film capacitor are shown in FIG. 6. FIG. 6 is a graph in which a horizontal axis represents frequency [Hz] and a vertical axis represents impedance [Ω]. Constants of each element are as written in the figure. That is, to-be-described L1=100 μH, and to-be-described C1=0.1 μF, and to-be-described L2 is increased from (a) to (f): 68 μH, 100 μH, 220 μH, 470 μH, 680 μH and 1000 μH.

There are resonance frequencies of both parallel resonance by the inductance element L1 and the capacitor element C1 and series resonance by the inductance element L2 and the inductance element L1 and the capacitor element C1. Hereinafter, the resonance frequency of the parallel resonance is referred to as a parallel resonance frequency and the resonance frequency of the series resonance is referred to as a series resonance frequency.

A parallel resonance frequency f0 (a first frequency f0) and a series resonance frequency f1 (a second frequency f1) are approximately as following. Incidentally, in reality, the values may differ since there are parasitic capacitance and parasitic inductance.

$$\begin{matrix}f 0 = 1 / \{ 2 π √ ( L 1 \times C 1 ) \} \\ f 1 = 1 / ( 1 / ( 2 \times π ) ) \times √ \{ ( L 1 + L 2 ) / ( L 1 \times L 2 \times C 1 ) \}\end{matrix}$$

L1: Inductance value of the inductance element L1
L2: Inductance value of the inductance element L2
C1: Capacitance value of the capacitor element C1

Here, in the graphs of FIG. 6, since the L1 and the C1 are fixed, the parallel resonance frequency f0 also does not change in the graphs.

In part (a) of FIG. 6, an impedance at the series resonance frequency f1 is about 2.5Ω. Here, a resonance impedance and a resonance frequency, which are measured when only the inductance element L2 and the capacitor element C1 are serially connected, are shown below.
1.2Ω Series resonance frequency 49.6 kHz (Condition L2: 100 μH, C1: 0.1 μF)
1.5Ω Series resonance frequency 33.5 kHz (Condition L2: 220 μH, C1: 0.1 μF)
2.5Ω Series resonance frequency 22.8 kHz (Condition L2: 470 μH, C1: 0.1 μF)
2.9Ω Series resonance frequency 19.2 kHz (Condition L2: 680 μH, C1: 0.1 μF)
3.8Ω Series resonance frequency 15.8 kHz (Condition L2: 1000 μH, C1: 0.1 μF)

In other words, the impedance at the series resonance in part (a) of FIG. 6 is very low and is not affected much by the parallel resonant circuit, and the series resonance can be said to exist as a substantially independent phenomenon.

On the other hand, in part (f) of FIG. 6, the series resonance frequency f1, whose frequency response is convex downward in the figure, is clearly present, however, the impedance at the series resonance frequency f1 is high, which is about 130Ω. In the impedance at the series resonance frequency f1 in part (f) of FIG. 6, a characteristic influenced by being high impedance due to the parallel resonant circuit can be observed. Here, the resonance impedance and the resonance frequency, which are measured when the inductance element L1 is fixed to 100 μH and the capacitor element C1 is fixed to 0.1 μF and the inductance element L2 is changed, are shown below.
2.5Ω Series resonance frequency 78.7 kHz (Condition L2: 68 μH) Values of part (a) of FIG. 6
3.8Ω Series resonance frequency 70.3 kHz (Condition L2: 100 μH) Values of part (b) of FIG. 6
6.4Ω Series resonance frequency 64.5 kHz (Condition L2: 150 μH)
12Ω Series resonance frequency 60.5 kHz (Condition L2: 220 μH) Values of part (c) of FIG. 6
22Ω Series resonance frequency 57.8 kHz (Condition L2: 330 μH)
41Ω Series resonance frequency 55.5 kHz (Condition L2: 470 μH) Values of part (d) of FIG. 6
80Ω Series resonance frequency 54.7 kHz (Condition L2: 680 μH) Values of part (e) of FIG. 6
130Ω Series resonance frequency 52.8 kHz (Condition L2: 1000 μH) Values of part (f) of FIG. 6

In other words, depending on the relative relationship of the values of the inductance element L2 to the inductance element L1, it is possible to increase the impedance while being the series resonance. From 150 μH, in which the value of the L2 is greater than that of the L1, the series resonance impedance can be increased more than the series resonance impedance when only the inductance element L2 and the capacitor element C1 are used, which is described above. For only increasing the impedance, it may be realized by adding resistors, however, this will cause electric power loss as well as a problem of lowering a boosting ratio.

### (on a General Series Resonant Circuit and a General Parallel Resonant Circuit)

Here, characteristics of a general series resonant circuit, in which an inductance element and a capacitor element are connected in series, will be described. In a series resonant circuit, since a significant current flows at a series resonance frequency, it is possible to exert circuit action using the series resonance frequency as a bandpass filter and to generate an AC voltage, which is greater than a power source voltage, in a reactance component of the series resonance circuit. However, since the extremely high current flows, electric power loss occurs due to a parasitic resistor component of an inductance element and a capacitor element and heat generation is likely to be a problem. In addition, since the extremely high current flows at the series resonance frequency, there is also a problem that frequency control is relatively difficult to handle.

In addition, in a case of a general parallel resonant circuit, in which an inductance element and a capacitor element are connected in parallel, by a current phase, which flows through the inductance element and the capacitor element, respectively, being shifted by 180°, substantially no current flows from a power source voltage and a high impedance results. From a different perspective, it can be seen as a current flows between the inductance element and the capacitor element like a pendulum. And in a case in which a connected point of the inductance element and the capacitor element, which are connected in parallel, is subject to switching drive, it shows a behavior in which a significant flyback voltage is generated upon switching off, and potential is made to be zero forcibly upon switching on. As a result, a voltage waveform is disturbed and becomes a waveform which is far from a sine wave.

### (Boosting Portion in the Embodiment 1)

On the other hand, as described above, in the boosting portion 10a in the Embodiment 1, depending on the relative relationship of the inductance element L2 to the inductance element L1, it becomes possible to increase the impedance while being the series resonance. In addition, in the boosting portion 10a, it is found that it becomes possible to, while keep having effect of the bandpass filter by the series resonance, appropriately increase the impedance of the series resonance frequency f1 to achieve low loss. In the characteristics shown in FIG. 6, part (c) of FIG. 6, part (d) of FIG. 6 and part (e) of FIG. 6 are appropriate.

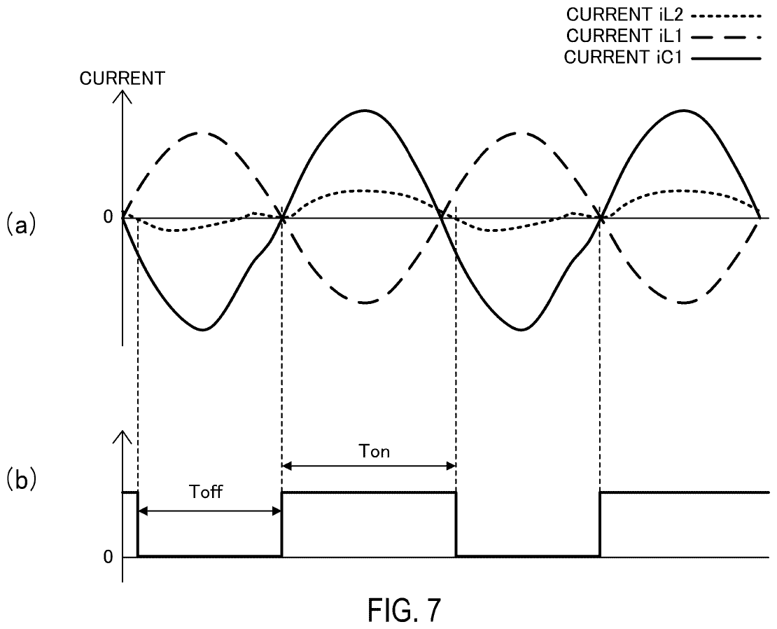

Using the characteristic in part (d) of FIG. 6 as an example, it will be described specifically using the figure. As shown in part (d) of FIG. 6, it is configured that the inductance element L2 is 470 μH, the inductance element L1 is 100 μH and the capacitor element C1 is 0.1 μF. In the boosting portion 10a at this time, a gate waveform when the single-ended drive by the FET31 in FIG. 5 at the series resonance frequency f1 is performed is shown in part (b) of FIG. 7, and each current waveform is shown in part (a) of FIG. 7. Here, it is defined that a current which flows through the inductance element L2 is a current iL2 (a dotted line in part (a) of FIG. 7), a current which flows through the inductance element L1 is a current iL1 (a broken line in part (a) of FIG. 7), and a current which flows through the capacitor element C1 is a current iC1 (a solid line in part (a) of FIG. 7). In addition, directions of each of the currents iL2, iL1 and iC1 are shown in FIG. 5.

The current iL2, which flows through the inductance element L2, i.e., a consumed current, which flows from the power source voltage Vcc to the boosting portion 10a, is small, and on the other hand, the current iL1, which flows through the inductance element L1, and the current iC1, which flows through the capacitor element C1, are more than the consumed current, respectively. This is because, through the inductance element L1 and the capacitor element C1, due to the parallel resonance behavior, the currents are flowing in opposite phases to each other. Through the inductance element L2, the current is flowing in the opposite phase to the inductance element L1. This can be seen that, as a behavior of the series resonance, a series resonance current is flowing from the capacitor element C1 to an inductance circuit, in which the inductance element L1 and the inductance element L2 are connected in parallel. Furthermore, through the capacitor element C1 and the inductance element L2, currents having the same polarity are flowing. On the other hand, through the inductance element L1, a current having reverse polarity is flowing, however, in a different perspective, upon reversing the direction of the arrow of the iL1 in FIG. 5, it can also be seen that a current having the same polarity as the inductance element L2 is flowing toward the power source voltage Vcc.

As a result, an approximately sine wave current from the power source voltage Vcc with a current value, which is several times larger than the consumed current, can be flowed through the inductance element L1 and the capacitor element C1. And it is found that, due to the reactance of the inductance element L1 and the capacitor element C1, a voltage, which is several times of the power source voltage Vcc, can be generated at the applying and outputting portion 7. That is, the high voltage generating circuit of resonance type 3 in the Embodiment 1 is constituted, and then the values of the inductance element L1 and the inductance element L2 are configured to have an appropriate relationship. That is, the inductance value L2 of the inductance element L2 is configured to be greater than the inductance value L1 of the inductance element L1 (L2>L1). And the driving frequency f of the driving portion 30 is set within a range of the parallel resonance frequency f0 or more and the series resonance frequency f1 or less (f0≤f≤f1), and the switching operation is performed to drive the boosting portion 10a. As a result, it is found that it becomes possible to solve both the problem of the loss reduction, which is difficult with a series resonance frequency drive of a series resonant circuit, and the problem of sine wave generation, which is difficult with a parallel resonance frequency of a parallel resonant circuit.

However, as shown in FIG. 7, it is found that the resonance current, which flows through the inductance element L2, is slightly disturbed relative to the current, which flows through the inductance element L1 and the capacitor element C1 of the parallel resonance, and a current phase to be a zero cross is slightly different relatively. On the other hand, while the resonance current, which flows through the inductance element L2, is flowing as a drain current of the FET31, if the FET31 is kept being turned on, then the voltage of the applying and outputting portion 7 gets large, and it also has effect to stability of the behavior and noise suppression. Therefore, while the resonance current, which flows the inductance L2, is flowing as the drain current of the FET31, since it is desirable to keep the FET31 being turned on, it is found that it is desirable that an on-duty width in the FET31 in FIG. 5 be set higher than 50%. In part (b) of FIG. 7, a gate driving voltage is, in other words, an on-duty Ton and an off-duty Toff of the driving signal are shown (Ton>Toff).

### (Appropriate Values for the Inductances L1 and L2)

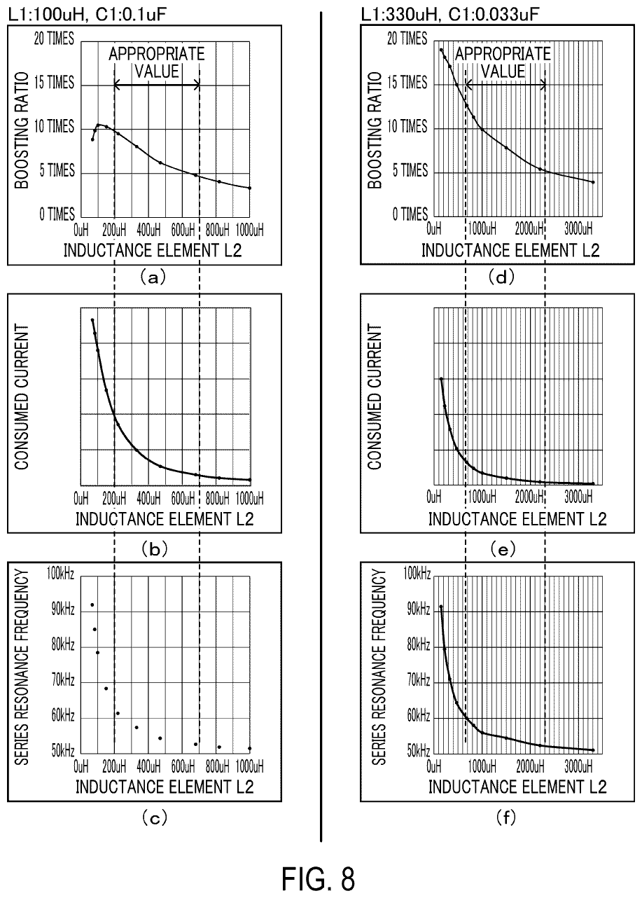

Next, appropriate constants for the inductance element L1 and the inductance element L2 will be described. In part (a) of FIG. 8 through part (c) of FIG. 8, when the inductance element L1 is set to 100 μH and the capacitor element C1 is set to 0.1 μF, results of measuring the characteristics of the boosting portion 10a, which changes depending on the value of the inductance element L2, are shown. In part (a) of FIG. 8, a vertical axis represents the boosting ratio. In part (a) of FIG. 8, the generated sine wave AC high voltage is represented as a multiplier to the power source voltage Vcc. In part (b) of FIG. 8, a characteristic of the consumed current is shown, and in part (c) of FIG. 8, the series resonance frequency f1 is shown. The horizontal axes in part (a) of FIG. 8 through part (c) of FIG. 8 all represent the value of the inductance element L2.

When the value of the inductance element L2 is less than approximately 200 μH, a voltage value of the high voltage, which is generated relatively to magnitude of the consumed current, is small (see parts (a) and (b) of FIG. 8), and in addition, the series resonance frequency f1 becomes 1.2 times of the parallel resonance frequency F0 (50.3 KHz) or more (see part (c) of FIG. 8) and is in a range where disturbance of the resonance current is concerned. It is found desirable, based on the results of the experimental measurements, that the series resonance frequency f1 be at least 1.3 times of the parallel resonance frequency f0 or less (f1≤f0×1.3). In addition, as the consumed current increases, a need to improve specifications for the elements in the driving portion 30 begins to arise, and it is likely for cost to be increased.

On the other hand, the larger the value of the inductance element L2, the less the consumed current and it becomes possible to reduce the loss. However, when the value exceeds approximately 700 μH, the voltage value of the generated high voltage becomes as small as three times of the power source voltage, and it is not suitable for a boosting purpose. Of course, if a target voltage with the boosting ratio of about three times is acceptable, then it can be used with the lower loss.

Next, in part (d) of FIG. 8 and following, the measurement results using the inductance element and the capacitor element having different constants are shown. Here, so as the resonance frequency to be approximately the same as in part (c) of FIG. 8, with respect to the above example, the constants are set as following. That is, when the inductance value of the inductance element L1 is 330 μH, which is 3.3 times of the above example, and the capacitance value of the capacitor element C1 is 0.033 μF, which is 0.33 times of the above example, characteristics graphs are shown in part (d) of FIG. 8, part (e) of FIG. 8 and part (f) of FIG. 8.

When the value of the inductance element L2 is less than approximately 650 μH, the voltage value of the high voltage, which is generated relative to the magnitude of the consumed current, is small, and in addition, the series resonance frequency f1 becomes 1.2 times of the parallel resonance frequency f0 or more and is in a range where disturbance of the resonance current is concerned. On the other hand, the larger the value of the inductance element L2, the less the consumed current and it becomes possible to reduce the loss. However, when above approximately 2300 μH, the voltage value of the generated high voltage becomes small and is not suitable for the boosting purpose.

Therefore, it is found that, for the value of the inductance element L2, an optimal constant is about from 2 times to 7 times of the inductance element L1 (2×L1≤L2≤7×L1). If the larger boosting ratio is desired than the low loss, then the ratio is configured to be on the 2 times side, and if the lower loss is desired than the boosting ratio, then the ratio is configured to be on the 7 times side. In addition, even when part (a) of FIG. 8 and part (d) of FIG. 8 have the same resonance frequency, it is found that in part (d) of FIG. 8, in which the value of the inductance element has a larger value, it becomes possible to achieve further low loss and make the boosting ratio higher. Upon analyzing this factor with actual inductance element and the capacitor, for the inductor, as the constant gets larger, both the reactance and the parasitic resistor component thereof get larger. On the other hand, for the capacitor, it is found that as the constant gets larger, the parasitic resistor component thereof increases more than the increase in the reactance thereof, and due to this resistor component, the loss is increased and the boosting of the voltage is suppressed.

However, a resistor component R cannot be generally specified due to a difference in a wire diameter, a core size, etc. of the inductor and a difference in a type, etc. of the capacitor. Thus, using an actual element, which has a winding inductor of drum shape of about 8 mm in diameter, and a film capacitor, which has a size of about from 5 mm to 10 mm, which are commonly used, measurement of the generated voltage is conducted.

When the inductance element L2, the inductance element L1 and the capacitor element C1 have the values listed below, the multipliers of the generated sine wave voltage (amplitude) to the power source voltage are shown. Incidentally, the boosting ratio is a slightly prioritized over the low loss, and the inductance L2 having the constant, which is close to three times of that of the inductance L1, is used. Under the following conditions, the resonance frequencies are approximately the same.

| | | |
|---|---|---|
| Boosting ratio | Approximately 10 | Condition 1: L2: 1000 μH, L1: |
| | times | 330 μH, C1: 0.033 μF |
| Boosting ratio | Approximately 7.6 | Condition 2: L2: 470 μH, L1: |
| | times | 150 μH, C1: 0.068 μF |
| Boosting ratio | Approximately 5.3 | Condition 3: L2: 330 μH, L1: |
| | times | 100 μH, C1: 0.10 μF |
| Boosting ratio | Approximately 3.2 | Condition 4: L2: 220 μH, L1: 68 |
| | times | μH, C1: 0.15 μF |
| Boosting ratio | Approximately 1.9 | Condition 5: L2: 100 μH, L1: 33 |
| | times | μH, C1: 0.33 μF |
| Boosting ratio | Approximately 1.2 | Condition 6: L2: 68 μH, L1: 22 |
| | times | μH, C1: 0.47 μF |

In the case of the general components described above, in order to obtain a value boosted about 5 times or more, it is necessary to configure the inductance L1 to have a greater value than the Condition 3. Since the larger the L1 and the smaller the C1, the higher the boosting ratio,
Upon defining with √(L1/C1),

$$√ ( L 1 / C 1 ) \geq √ ( 100 / 0.1 ) \approx 30$$

about such is a criterion. However, in reality, there is an upper limit to an inductance value of an inductance element which can be produced for the same core size, and it is desirable that the constants be determined while taking the component sizes and cost thereof into consideration.

As described above, according to the Embodiment 1, with a more compact and inexpensive configuration, it becomes possible to generate the sine wave AC high voltage with good electric power efficiency.

### Embodiment 2

Next, an Embodiment 2 will be described with focusing on differences from the Embodiment 1. The Embodiment 2 is a configuration in which the microcomputer 501 is responsible for the generation of the clock signal by the VCO 2 and the feedback control by the constant voltage control circuit 201 in the Embodiment 1. In addition, in contrast to the Embodiment 1, in which the circuit of the driving portion 30 is a single-ended drive system, the boosting portion 10 is driven by a circuit of a push-pull drive system.

### (Outline Description of an Overall Circuit Operation)

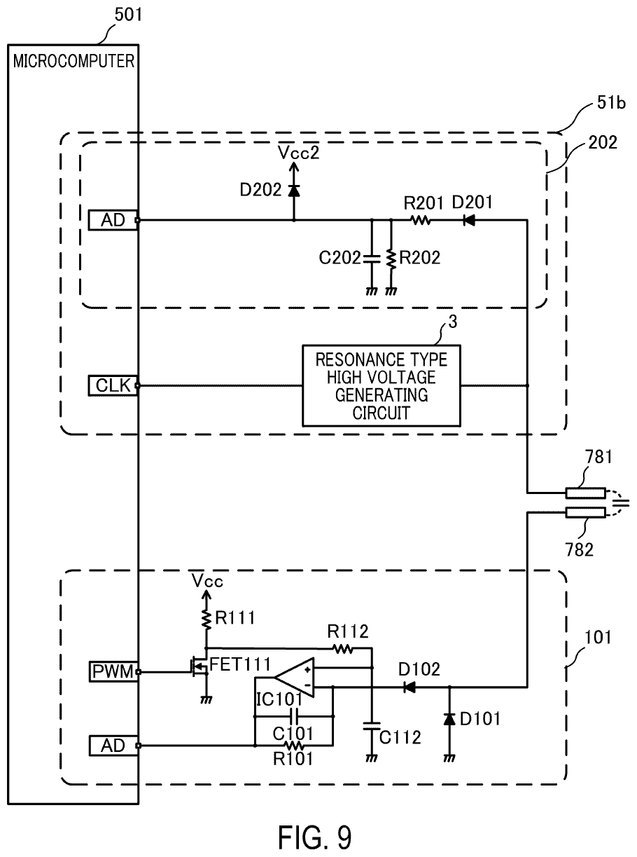

FIG. 9 is a block diagram of a toner remaining amount detection mechanism in the Embodiment 2, which is constituted by the microcomputer 501, a high voltage applying portion 51b, the electrostatic capacitance detecting portion 101, the first contact portion 781 and the second contact portion 782. In the high voltage applying portion 51b, an output voltage detection circuit 202 is further constituted.

When the microcomputer 501 outputs a clock signal having a predetermined frequency to the high voltage generating circuit of resonance type 3, the high voltage generating circuit of resonance type 3 generates a sine wave AC high voltage corresponding to the input clock signal and applies the voltage to the first contact portion 781. This sine wave AC high voltage is divided and half-wave rectified by the diode D201, the resistor R201, the resistor R202 and the capacitor C202 of the output voltage detection circuit 202, and is sent out to an AD terminal of the microcomputer 501. The microcomputer 501 gradually increases the frequency of the clock signal, which is sent out to the high voltage generating circuit of resonance type 3, in a sweep so that a detected voltage becomes a target voltage, which is set in advance and stored in an unshown memory inside the microcomputer.

The high voltage generating circuit of resonance type 3 outputs a voltage corresponding to a frequency which is subject to switching drive. By the microcomputer 501 performing repeatedly this increase in sweeping of the frequency and monitoring of the detected voltage, feedback control of the AC voltage, which is generated by a software of the microcomputer 501, is executed. Incidentally, the diode D202 prevents a voltage, which is from a power source voltage Vcc2, from being input to the AD port of the microcomputer 501.

Incidentally, upon starting to sweep from a very low frequency relative to a resonance frequency, an impedance of the inductance element becomes extremely low relatively. Therefore, there is a risk that circuit is damaged due to an over current, which is excessively larger than normal time, flowing transiently, and on the other hand, upon improving specifications for components to prevent the circuit from being damaged, the cost increases. Therefore, it is necessary for the clock signal to be swept to be started from a higher frequency to some extent. On the other hand, if the frequency is too close to a series resonance frequency, at which the output voltage becomes highest, it becomes likely to overshoot immediately after the sweep starts. Therefore, it is desirable to start the sweep at a frequency of 0.1 times to 0.8 times of the series resonance frequency f1 (0.1×f1≤f≤0.8×f1). This is also true for the VCO 2 in the Embodiment 1.

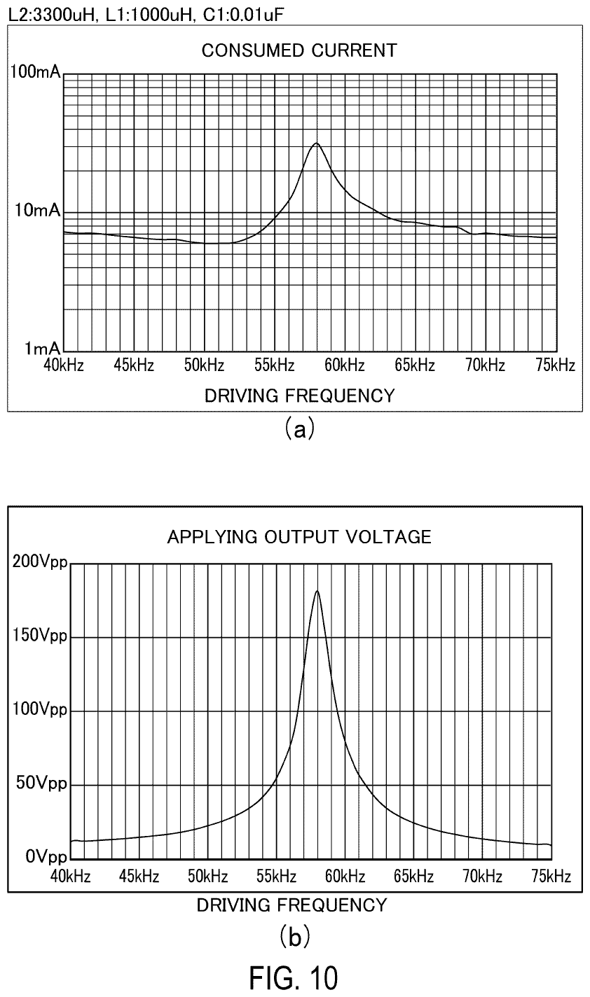

Here, in FIG. 10, frequency response, which is measured when a power source voltage is set to 24 V, the inductance element L2 is set to 3300 μH, the inductance element L1 is set to 1000 μH and the capacitor element C1 is set to 0.01 ρF, is exemplified. Graphs in FIG. 10 show the frequency (driving frequency) of the clock signal.

The series resonance frequency f1 is 58 kHz approximately, where the maximum voltage is generated. Part (a) of FIG. 10 shows relationship between the driving frequency and a consumed current, and part (b) of FIG. 10 shows relationship between the driving frequency and an amplitude value of the generated AC voltage. Assuming that the target voltage is 150 Vpp, the frequency sweep is started at about 40 kHz, which is within the above range. Then, from part (b) of FIG. 10, 150. Vpp is reached at about 57.2 Hz, and from part (a) of FIG. 10, the consumed current is about mA.

### (Driving Portion of the Push-Pull Drive System)

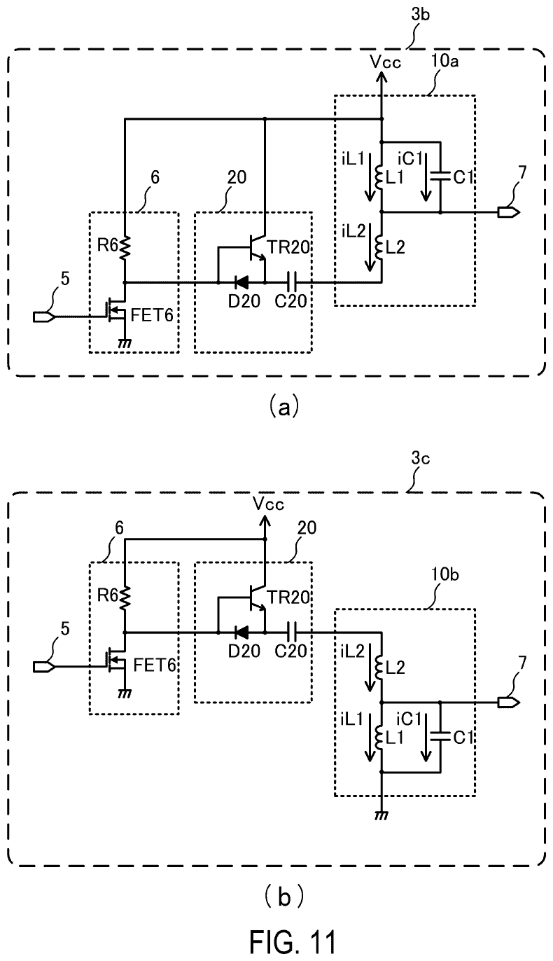

Next, a high voltage generating circuit of resonance type 3b in the Embodiment 2, which includes a driving portion 20 of the push-pull drive system, will be described using part (a) of FIG. 11. The high voltage generating circuit of resonance type 3b is constituted by the voltage conversion switching portion 6, the driving portion 20 and the boosting portion 10a. The configurations of the voltage conversion switching portion 6 and the boosting portion 10a are the same as in the Embodiment 1, and the description thereof will be omitted.

The driving portion 20 in the Embodiment 2 includes a transistor TR20, a coupling capacitor C20 and a diode D20. Of the transistor TR20, a collector terminal is connected to the power source voltage Vcc, an emitter terminal is connected to the coupling capacitor C20, and a base terminal is connected to the voltage conversion switching portion 6. The diode D20 is connected between the emitter terminal and the base terminal of the transistor TR20. Specifically, of the diode D20, an anode terminal is connected to the emitter terminal of the transistor TR20 and to the coupling capacitor C20, and a cathode terminal is connected to the base terminals of the transistor TR20 and to the voltage conversion switching portion 6.

When the clock signal, which is sent out from the voltage conversion switching portion 6, is a High logic, a base current of the transistor TR20 flows. By this, an amplified current as a source current flows from the emitter terminal of the transistor TR20 to the boosting portion 10a via the coupling capacitor C20 and drives the boosting portion 10a. When the clock signal, which is sent out from the voltage conversion switching portion 6, transitions to a Low logic, the base current of the transistor TR20 stops flowing and the transistor TR20 is turned off. And a current is sunk from the boosting portion 10a via the diode D20 and the coupling capacitor C20 and drives the boosting portion 10s. Since the coupling capacitor C20 intervenes, only push-pull alternating current flows.

The driving portion 20 in the Embodiment 2 becomes, unlike the Embodiment 1, a switching with low impedance, which is a current source from the power source voltage Vcc and a current sink to the GND potential. Therefore, the flyback voltage does not occur as in the Embodiment 1, and the snubber circuit and the FET having high voltage resistance become not required, and it becomes possible to realize the more inexpensive configuration. In addition, for being the push-pull drive, it has an advantage that the zero cross phases of the AC currents, which flow through the inductance element L2, the inductance element L1 and the capacitor element C1, are not shifted from each other. Since accuracy of the sine waveform is improved, it is preferable that the driving portion 20 be driven at 50% of on-duty.

### (Modified Examples of the Boosting Portion)

Here, a high voltage generating circuit of resonance type 3c in part (b) of FIG. 11, which differs from the high voltage generating circuit of resonance type 3b in part (a) of FIG. 11, will be described. Incidentally, the driving portion 20 and the voltage conversion switching portion 6 of the push-pull drive system are the same as in part (a) of FIG. 11. The boosting portion 10a in part (a) of FIG. 11 illustrates the case in which the inductance element L2 is connected to the power source voltage Vcc via the inductance element L1. A boosting portion 10b in part (b) of FIG. 11 illustrates a case in which the inductance element L2 is connected to the GND potential via the inductance element L1. In other words, in part (b) of FIG. 11, one end of the inductance element L1 is connected to the ground potential. There is no significant difference between both cases except that a difference in DC potential, which is used as a reference for operation, arises and the DC potential of the coupling capacitor C20 is different. However, the case in part (a) of FIG. 11, in which the inductance element L2 is connected to the power source voltage Vcc, has an advantage that an operation potential becomes higher, albeit slightly, and the voltage of the applying and outputting portion 7 becomes higher.

In addition, the boosting operation by the switching drive is possible even without the coupling capacitor C20 in the configuration. However, in a case in which the on-duty of the clock signal, which is subject to the switching drive, deviates from 50% due to variations in components, etc., the DC consumed current is superimposed, and the consumed current is increased, albeit slightly. In addition, since the coupling capacitor C20 only conducts an alternating current, it also has effect to suppress that a DC-like over current flows due to the on-duty getting longer in an on-off transient state, etc. of the power source voltage.

In addition, in the above description, the push-pull drive circuit using the transistor and the diode of individual semiconductors is described, however, it may be substituted by a half-bridge gate driver IC of an integrated semiconductor, etc.

As described above, according to the Embodiment 2, with a more compact and inexpensive configuration, it becomes possible to generate the sine wave AC high voltage with good electric power efficiency.

### Embodiment 3

Next, an Embodiment 3 will be described with focusing on differences from the Embodiment 1. The Embodiment 3 is a configuration which uses, in contrast that the boosting portion 10 in the Embodiments 1 and 2 is constituted by the inductance element and the capacitor element, a winding transformer 12 (transformer) for high voltage to generate the high voltage of even higher output.

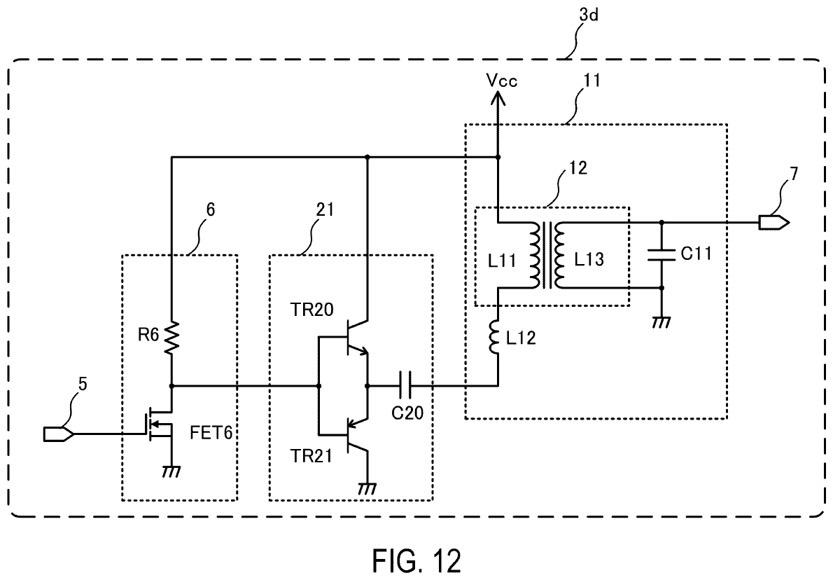

In FIG. 12, a high voltage generating circuit of resonance type 3d in the Embodiment 3 is shown. The high voltage generating circuit of resonance type 3d is constituted by the voltage conversion switching portion 6, a driving portion 21 and a boosting portion 11. The driving portion 21 in the Embodiment 3 includes the transistor TR20, a transistor TR21, and the coupling capacitor C20. Of the transistor TR20, the collector terminal is connected to the power source voltage Vcc, the emitter terminal is connected to the coupling capacitor C20, and the base terminal is connected to the voltage conversion switching portion 6. The transistor TR21 is connected between the emitter terminal and the base terminal of the transistor TR20. In other words, of the transistor TR21, an emitter terminal is connected to the emitter terminal of the transistor TR20 and the coupling capacitor C20, a base terminal is connected to the base terminal of the transistor TR20 and the voltage conversion switching portion 6, and a collector terminal is connected to the GND potential. Since the configuration of the voltage conversion switching portion 6 is the same as in the Embodiment 1 or in the Embodiment 2, the description thereof will be omitted.

The boosting portion 11 is constituted by an inductance element L12, a winding transformer for high voltage 12 and a high voltage capacitor element C11. Furthermore, the winding transformer for high voltage 12 constitutes a primary winding L11 and a high voltage secondary winding L13. The inductance element L12 and the primary winding L11 are subject to switching drive by the driving portion 21 as in the Embodiment 2, and a sine wave AC high voltage having an amplitude value, which is several times of the power source voltage Vcc, is generated at a primary winding L11 end.

In the Embodiment 3, this high voltage generated at the primary winding L11 end is further boosted, according to turns ratio between the primary winding L11 and the high voltage secondary winding L13, to generate a voltage at a secondary winding L13 end.

In other words, in the Embodiment 1 and the Embodiment 2, when the power source voltage is 24 V, for example, the sine wave high voltage of about 100 V to 200 V is generated. In contrast, in the Embodiment 3, since a sine wave high voltage with an amplitude value of several kV can be generated, even in a case of smaller electrostatic capacitance, it becomes easier to detect because of an expansion of a dynamic range. Furthermore, when a rectifying circuit, which uses a high voltage diode on the secondary side, is constituted, it also becomes possible to obtain a DC high voltage from this sine wave AC high voltage.

The parallel resonance frequency f0 is uniquely determined from the primary winding L11 and the high voltage secondary winding L13 of the winding transformer for high voltage 12, and the high voltage capacitor element C11. In addition, the series resonance frequency f1 is uniquely determined from the primary winding L11 and the high voltage secondary winding L13 of the winding transformer for high voltage 12, the high voltage capacitor element C11 and the inductance element L12. In comparison to the inductance element L2 in the Embodiment 1 and the Embodiment 2, an inductance, in which the inductance element L12 and a leakage inductance of the winding transformer for high voltage 12 are synthesized, works similarly in the Embodiment 3.

A capacitance of the high voltage capacitor element C11 can be converted and calculated to a primary side according to the turns ratio between the primary winding L11 and the high voltage secondary winding L13.

Next, the driving portion 21 of the push-pull drive system will be described. When the clock signal, which is sent out from the voltage conversion switching portion 6, is the High logic, a base current of the transistor TR20 flows. By this, an amplified current as a source current flows from the emitter terminal of the transistor TR20 to the boosting portion 11 via the coupling capacitor C20 and drives the boosting portion 11. When the clock signal, which is sent out from the voltage conversion switching portion 6, transitions to the Low logic, the base current of the transistor TR20 stops flowing and the transistor TR20 is turned off. On the other hand, by the base current being drawn to the transistor TR21, the amplified current is sunk from the collector terminal of the transistor TR21 to the GND potential via the coupling capacitor C20 and drives the boosting portion 11. The driving portion 21 described in the Embodiment 3 can lower a current, which the FET6 sinks.

As described above, according to the Embodiment 3, with a more compact and inexpensive configuration, it becomes possible to generate the sine wave AC high voltage with good electric power efficiency.

### OTHER EMBODIMENTS

The present invention may also be realized by a process in which a program realizing one or more functions of the Embodiments described above is supplied to the system or the device via a network or the storage medium, and a one or more processors in a computer of the system or the device read out and execute the program. In addition, the present invention can also be realized by a circuit which realizes one or more functions thereof (e.g., ASIC).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-035282 filed on Mar. 7, 2024, which is hereby incorporated by reference herein in its entirety.

What is claimed is:

1. A high voltage generating device for converting a DC voltage to an AC voltage, the high voltage generating device comprising:
a boosting portion including a first inductor of which one end is connected to the DC voltage or a ground potential, a second inductor of which one end is connected in series to the other end of first inductor, and a capacitor of which both ends are connected in parallel to the first inductor; and
a driving portion connected in series to the other end of the second inductor and configured to perform a switching operation by a driving signal,
wherein an inductance value L2 of the second inductor is larger than an inductance value L1 of the first inductor,
wherein when a resonance frequency by the first inductor and the capacitor is defined as a first frequency f0, a resonance frequency by the capacitor and both the first inductor and the second inductor is defined as a second frequency f1, and a driving frequency of the driving signal is defined as a driving frequency f, the driving portion performs the switching operation at the driving frequency f within a range of f0≤f≤f1, and
wherein the boosting portion is driven by the driving portion and generates a sine wave AC high voltage higher than the DC voltage.

2. The high voltage generating device according to claim 1, wherein the L2 satisfies
$$2 \times L 1 \leq L 2 \leq 7 \times L 1 .$$

3. The high voltage generating device according to claim 1, wherein when a capacitance of the capacitor is defined as C, the L1 and the C satisfy
$$√ ( L 1 / C ) \geq 30 .$$

4. The high voltage generating device according to claim 1, wherein the first frequency f0 and the second frequency f1 satisfy
$$f 1 \leq f 0 \times 1.3 .$$

5. The high voltage generating device according to claim 1, wherein the driving portion gradually increases the driving frequency f from a value of 0.1 times to 0.8 times of the second frequency.

6. The high voltage generating device according to claim 1, wherein the driving portion includes a field effect transistor by a single-ended drive system, and
wherein an on-duty width of the driving signal is higher than 50%.

7. The high voltage generating device according to claim 1, wherein the driving portion is a driving circuit by a push-pull drive system, and
wherein an on-duty width of the driving signal is 50%.

8. The high voltage generating device according to claim 1, further comprising a rectifying circuit configured to rectify the sine wave AC high voltage generated by the boosting portion and generate a DC high voltage.

9. The high voltage generating device according to claim 1, wherein the first inductor and the second inductor are coils.

10. The high voltage generating device according to claim 1, wherein the first inductor is a transformer and the second inductor is a coil.

11. An electrostatic capacitance detecting device comprising:
a first electrode member; and
a second electrode member paired with the first electrode member,
wherein the electrostatic capacitance detecting device detects an electrostatic capacitance between the first electrode member and the second electrode member and is provided with a high voltage generating device according to claim 1, and
wherein the high voltage generating device applies the sine wave AC high voltage to the first electrode member.

12. The electrostatic capacitance detecting device according to claim 11, wherein the electrostatic capacitance is formed by toner of an image forming apparatus.

13. An image forming apparatus comprising:
an image bearing member configured to bear an electrostatic latent image;
a developing means configured to develop the electrostatic latent image with toner and form a toner image;
an accommodating chamber configured to accommodate the toner to be supplied to the developing means; and
an electrostatic capacitance detecting device according to claim 11 and attached to the accommodating chamber,
wherein the electrostatic capacitance detecting device detects a electrostatic capacitance of the toner entered between the first electrode member and the second electrode member, and
the image forming apparatus is provided with an estimating means configured to estimate an amount of the toner accommodated in the accommodating chamber based on the electrostatic capacitance detected by the electrostatic capacitance detecting device.
